(19) United States
(12) Patent Application Publication
(10) Pub. No.: US 2012/0222946 A1
(43) Pub. Date: Sep. 6, 2012

(54) Key Module, Keyboard and Electric Device

(76) Inventor: Ching-Cheng TSAI, Keelung City (TW)

(21) Appl. No.: 13/151,027

(22) Filed: Jun. 1, 2011

(30) Foreign Application Priority Data
Mar. 4, 2011 (TW) 100203905

(51) Int. Cl. H01H 13/76; H01H 9/02

(52) U.S. Cl. 200/5 A; 200/310

(57) ABSTRACT

A key module, keyboard and electric device are provided in this invention. The key module includes a metal substrate, a circuit board stacked on the metal substrate, a light-emitted element installed on the circuit board, and a film flat disposed on the circuit board and covering the light-emitted element. The circuit board is provided with a plurality of apertures capable of exposing the metal substrate beneath. The film is with a light-pervious portion and a plurality of penetrating holes. The light-pervious portion is installed on the film to align with the light-emitted element. The penetrating holes are arranged on the film to surround the light-pervious portion and to align with the apertures one on one.

### RELATED APPLICATIONS

This application claims priority to Taiwan Patent Application Serial Number 100203905, filed Mar. 4, 2011, which is herein incorporated by reference.

### BACKGROUND

1. Technical Field

The present invention relates to a key module, more particular to a key module having indicating light, a keyboard having the key module, and an electric device having the keyboard.

2. Description of Related Art

Recently, when a user operates a portable electrical device (e.g. notebooks or intellectual mobile phone) in a location of dusk environment, the user may not be able to recognize clearly numbers and letters expressed on key caps of a keyboard of the portable electrical device so as to be difficult for operating the portable electrical device, moreover, the user may deteriorate his/her vision when overexerting to recognize them on key caps by eyes.

Thus, the keyboard makers further additionally provide indicating lights for specified key of the keyboard to overcome the mentioned inconvenience. Furthermore, by different presentations of the indicating lights (e.g. light, dark or twinkle), the users can be informed messages of statuses such as function enabling or disable so as to facilitate the operation of the portable electrical device.

For instance, a base module of the conventional keyboard having the mentioned indicating lights on its specific keys comprising a circuit board, an emitting element and a pad. The emitting element is configured on the circuit board, and arranged between the circuit board and the pad. Besides, a location of the pad corresponding to the emitting element is provided with a through hole, and a key cap of the specific key is located above the pad, and the key cap of the specific key is with a light pervious structure thereon. Thus, lights of the emitting element can pass the through hole and the light pervious structure to present brightness on a surface of the key cap. Also, an elastic member of the specific key is directly coupled to a surface of the pad, and a switch is configured on the circuit board corresponding to the elastic member. When the specific key is pressed to compress the elastic member, the elastic member is thus deformed to activate the switch so as to inform the specific key being pushed.

However, when proceeding a EMI (Electromagnetic Disturbance) test on the keyboard of the portable electrical device, static electricity usually goes through the pad via the through hole of the pad so as to electric shock and damage the emitting element.

### SUMMARY

The present invention is to disclose a key module, a keyboard and an electric device, which are served for providing a function of indicating lights.

The present invention is to disclose a key module, a keyboard and an electric device, which are served for decreasing or even eliminating possibilities that light-emitted elements being electric shocked and damaged by static electricity during an EMI test.

The present invention is to disclose a key module, a keyboard and an electric device, which are served for effectively positioning the light-emitted elements on the film.

According to an embodiment of the key module, the key module includes a metal substrate, a circuit board stacked on the metal substrate, a light-emitted element installed on the circuit board, and a film flat disposed on the circuit board and covering the light-emitted element. The circuit board is provided with a plurality of apertures capable of exposing the metal substrate beneath. The film is with a light-pervious portion and a plurality of penetrating holes. The light-pervious portion is installed on the film to align with the light-emitted element. The penetrating holes are arranged on the film to surround the light-pervious portion and to align with the apertures one on one.

Other types of the invention are to provide a keyboard with a key module mentioned above and an electric device with a key module mentioned above.

To sum up, the key module of the invention can decrease or even eliminate possibilities of the light-emitted elements being electric shocked and damaged by static electricity during an EMI test. Moreover, those penetrating holes are operated to help to position the light-emitted elements on the film so as to reduce assembly labor costs and time.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view of a key module according to a first embodiment of the present invention.

FIG. 2 is a side view of the key module of FIG. 1 after assembling.

FIG. 3 is an exploded view of a key module according to a second embodiment of the present invention.

FIG. 4 is a side view of the key module of FIG. 3 after assembling.

FIG. 5 is a schematic view of an electric device and its partially enlarged view according to the first embodiment of the present invention.

### DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The present invention is to provide a key module, a keyboard and an electric device, according the present invention, by providing a shortest path that static electricity being electrically conducted to a ground, when the key module is tested during an EMI test, the static electricity arrived on the key module has been leaded to the ground before the light-emitted elements are electric shocked by the static electricity so as to decrease or even eliminate possibilities that light-emitted elements being electric shocked and damaged by static electricity.

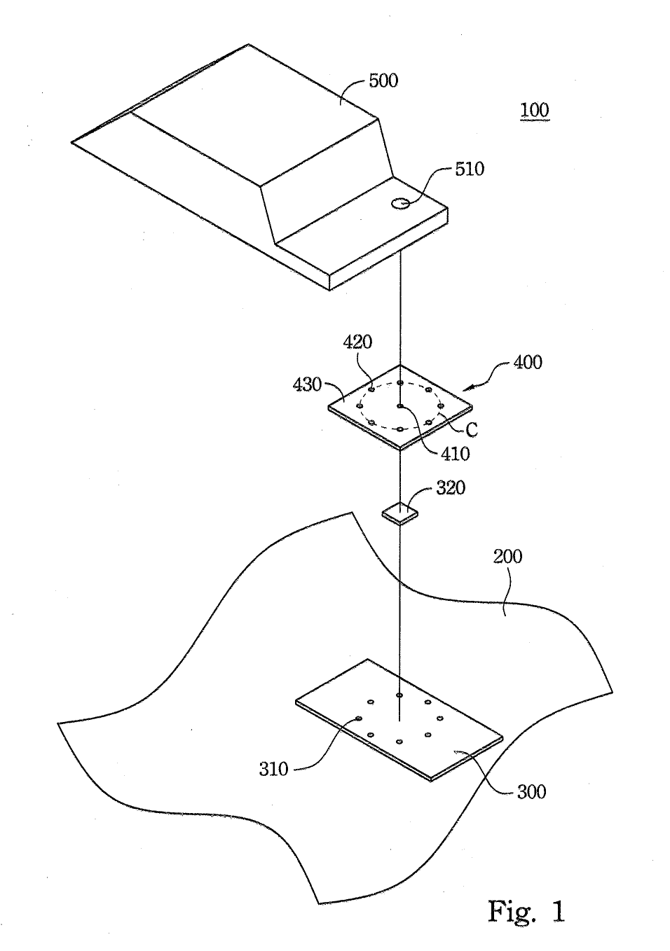

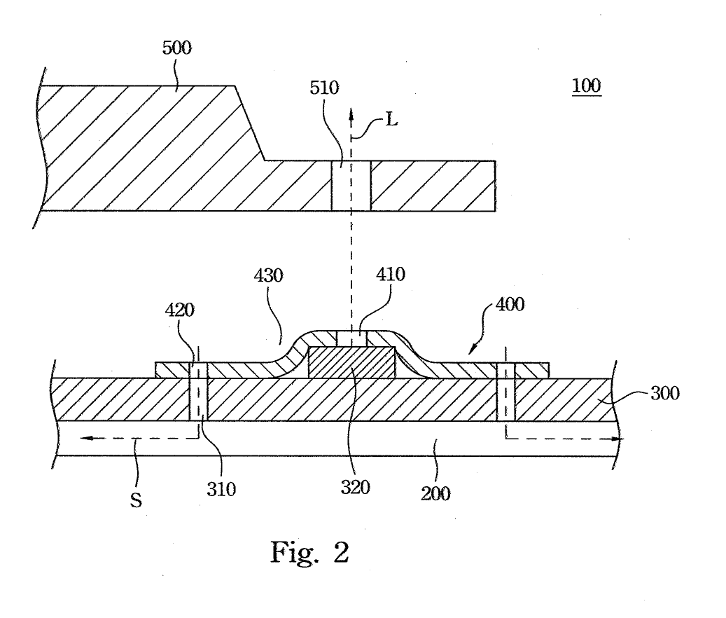

Refer to FIG. 1 and FIG. 2 in which FIG. 1 is an exploded view of a key module 100 according to a first embodiment of the present invention, and FIG. 2 is a side view of the key module 100 of FIG. 1 after assembling.

The key module 100 of the present invention includes a metal substrate 200, a circuit board 300, at least one light-emitted element 320 and at least one film 400. The circuit board 300 is stacked on one surface of the metal substrate 200, and is provided with a plurality of apertures 310 exposing the metal substrate 200 beneath. The light-emitted element 320 is installed on one surface of the circuit board 300, and the light-emitted element 320 receives power and signals for emitting via the circuit board 300. The film 400 is flat disposed on the surface of the circuit board 300 and covers the light-emitted element 320, thus, the light-emitted element 320 is disposed between the film 400 and the circuit board 300. The film 400 is provided with a light-pervious portion 410 and a plurality of penetrating holes 420. The light-pervious portion 410 is installed on the film 400 to align with a light output face of the light-emitted element 320, thus, a light L emitted by the light-emitted element 320 can transmit through the light-pervious portion 410. These penetrating holes 420 are installed on the film 400 to surround the light-pervious portion 410 together therein by an imaginary loop C arranged by the penetrating holes 420. Also, the penetrating holes 420 are arranged to align with the apertures 310 beneath one on one, thus, each penetrating hole 420 and its aligned correspondingly aperture 310 can form a channel so as each penetrating hole 420 can expose the metal substrate 200 beneath through its aligned correspondingly aperture 310.

Thus, refer to FIG. 2, when processing an EMI test on the key module 100, most of static electricity S is highly possible to be guided to the metal substrate 200 first via any of the penetrating holes 420 and its aligned aperture 310 before the static electricity S arrives the light-pervious portion 410 of the film 400. The static electricity S is then guided to a ground (not shown) via the metal substrate 200. Thus, the possibilities of the light-emitted elements 320 being electric shocked and damaged by static electricity S can be reduced.

Furthermore, since the light-pervious portion 410 is surrounded by the penetrating holes 420, thus, the operation worker only needs to arrange a light output face of each light-emitted element 320 to align with the imaginary loop C arranged by the penetrating holes 420 rather than arrange the light output face of each light-emitted element 320 to align with the light-pervious portion 410 of the film 400 so as to reduce assembly labor costs and time.

Substantially, the film 400 further comprises an opaque portion 430 (e.g. black mask or coating). The opaque portion 430 surrounds the light-pervious portion 410, thus, the light L emitted by the light-emitted element 320 and transmitted through the light-pervious portion 410 will be more obviously.

In the first embodiment, since the film 400 does not need to be punched protrusions thereon, thus, the film 400 has no punched protrusion thereon so as to save costs of punching process.

Also, because the film 400 is flexible, thus, after the film 400 is flat blanketed on both the circuit board 300 and the light-emitted element 320, the film 400 is physically contacted with the light-emitting element 320.

In one variation of the first embodiment, the first light-pervious portion 410 can be practiced as an opening penetrating through the film 400. The opening is aligned with a light output face of the light-emitted element 320, so as to output some lights L of the light-emitted element 320 from the opening.

Optionally, the thickness of the film 400 can be properly enlarged (e.g. 1 mm) to deepen the hole depth of the opening, thus, lights from the light-emitted element 320 with smaller deviation angles can be transmitted through the opening. Therefore, the lights transmitted through the opening will follow a consistent direction rather than being spread omni-directionally so as to prevent from bad vision effects.

In another variation of the first embodiment, the first light-pervious portion 410 can be practiced as a light-pervious pattern (e.g. transparent or semi-transparent) printed on the film 400, and not penetrating through the film 400. The light-pervious pattern is aligned with a light output face of the light-emitted element 320, so as to output some lights L of the light-emitted element 320 from the light-pervious pattern.

Be aware of that when the first light-pervious portion 410 is a light-pervious pattern not penetrating through the film 400, the first light-pervious portion 410 may also isolate the static electricity S away from the light-emitted element 320 so as to prevent from the light-emitted element 320 being damaged by the static electricity S.

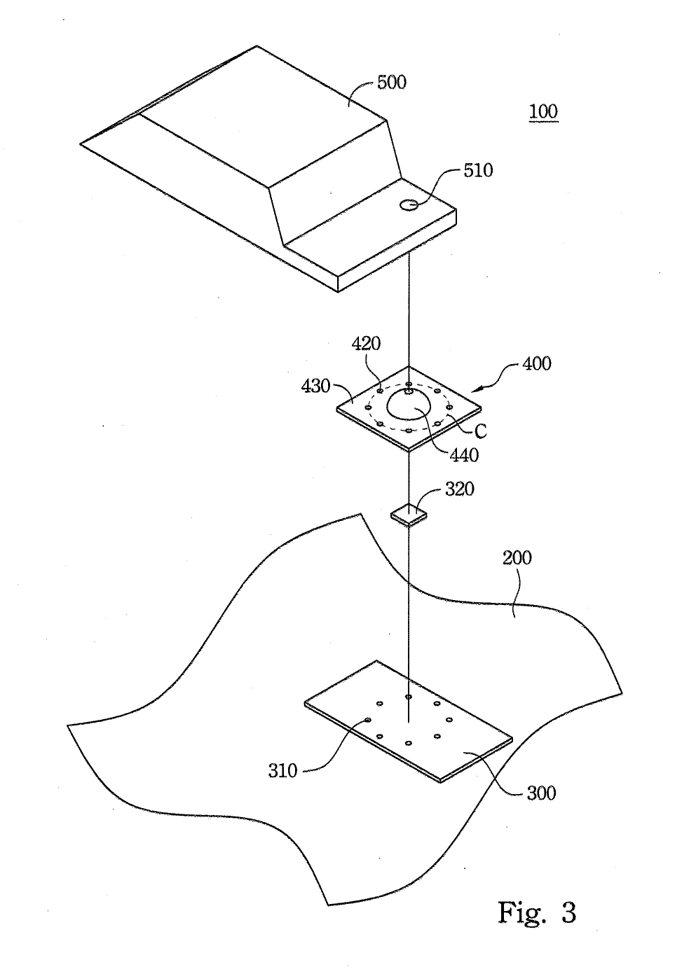

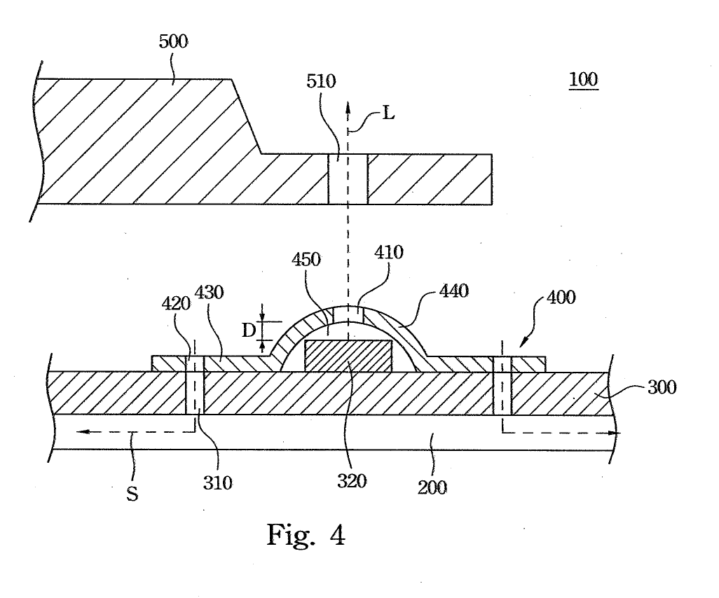

Refer to FIG. 3 and FIG. 4, in which FIG. 3 is an exploded view of a key module 100 according to a second embodiment of the present invention, and FIG. 4 is a side view of the key module 100 of FIG. 3 after assembling.

In the second embodiment, the film 400 can be previously punched to generate a punched protrusion 440 thereon. The punched protrusion 440 perpendicularly stands on the surface of the film 400, and has a containing space 450 (FIG. 4) therein. The punched protrusion 440 for example can be shaped as a hemisphere, and the first light-pervious portion 410 is disposed on a top of the punched protrusion 440 so as to straightly align a light output face of the light-emitted element 320. When the film 400 is placed on both the circuit board 300 and the light-emitted element 320, the punched protrusion 440 covers the light-emitted element 320 so the light-emitting element 320 is in the containing space 450, and the punched protrusion 440 remains a distance D with a light output face of the light-emitting element 320.

Therefore, even through lights from the light-emitted element 320 with larger deviation angles might be absorbed or reflected by inner walls of the punched protrusion 440, however, on the other hand, lights from the light-emitted element 320 with smaller deviation angles might be transmitted through the first light-pervious portion 410 of the punched protrusion 440. In other words, the light L transmitted through the first light-pervious portion 410 will follow a consistent direction rather than being spread omni-directionally so as to prevent from bad vision effects.

In one variation of the second embodiment, the first light-pervious portion 410 can be practiced as an opening penetrating through the film 400. The opening is aligned with a light output face of the light-emitted element 320, so as to output some lights L of the light-emitted element 320 from the opening.

In another variation of the second embodiment, the first light-pervious portion 410 can be practiced as a light-pervious pattern (e.g. transparent or semi-transparent) printed on the film 400, and not penetrating through the film 400. The light-pervious pattern is aligned with a light output face of the light-emitted element 320, so as to output some lights L of the light-emitted element 320 from the light-pervious pattern.

Be aware of that when the first light-pervious portion 410 is a light-pervious pattern, the first light-pervious portion 410 may also isolate the static electricity S away from the light-emitted element 320 so as to prevent from the light-emitted element 320 being damaged by the static electricity S.

Refer to FIG. 2 and FIG. 4, the embodiments of the present invention mentioned above do not limit the light-emitted element 320 and the film 400 in quantity. The film 400 can be practiced as a single film 400 with large area or plural films 400 with small area. So when the film 400 is a single film 400 with large area, and the light-emitted elements 320 are plural in quantity, the film 400 covers both the circuit board 300 and the light-emitting elements 320. On the other hand, when the film 400 is a single film 400 with large area, and the light-emitted elements 320 are plural in quantity, each film 400 covers the circuit board and only one light-emitting element 320.

Also, the embodiments of the present invention mentioned above do not limit the type and material of the circuit board, the light-emitting element and film. In the embodiments of the present invention mentioned above, the circuit board, for example, can be a membrane circuit board; each of the light-emitting elements, for example, can be a light emitting diode; the film, for example, can be made of polyester resin.

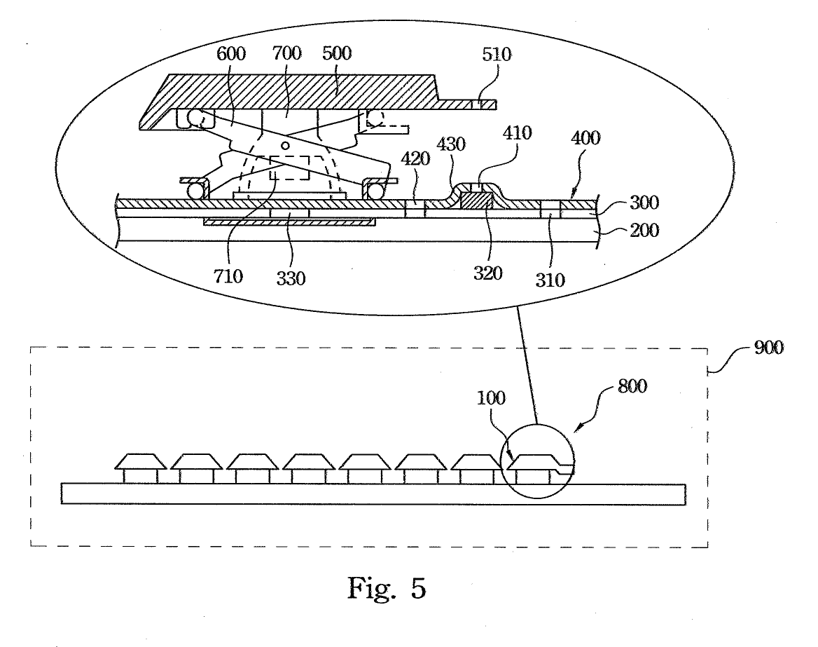

Refer to FIG. 5 in which FIG. 5 is a schematic view of an electric device 900 and its partially enlarged view according to the first embodiment of the present invention.

The embodiments of the present invention mentioned above further include a key cap 500, a scissors-structure 600, an elastic member 700, and a key switch 330. The key cap 500 is disposed above the film 400, and comprises a second light-pervious portion 510 aligning to the first light-pervious portion 410. The elastic member 700 is arranged between the metal substrate 200 and the key cap 500 for supporting and providing a restoring force when the key cap 500 is pressed. The scissors-structure 600 couples both the key cap 500 and the metal substrate 200, preferably, the scissors-structure 600 is respectively pivotally disposed on the key cap 500 and the metal substrate 200, so when the key cap 500 is pressed, the scissors-structure 600 can support the key cap 500 moving vertically opposite to the metal substrate 200. The key switch 330 is aligned with a trigger 710 of the elastic member 700. When the scissors-structure 600 is moved with the key cap 500 to approach the metal substrate 200 and to deform the elastic member 700, the trigger 710 of the elastic member 700 activates the key switch 330 so as to issue a signal representing the key cap 500.

Meanwhile, after the light-emitting element 320 receives the signal via the circuit board 300, lights L from the light-emitting element 320 will be transmitted outwards via the first light-pervious portion 410 and the second light-pervious portion 510 in a proper moment.

Refer to FIG. 5 again, the mentioned key module 100 in the embodiments of the present invention can be implemented on a keyboard 800, thus, one or more keys in the keyboard 800 can have an indicating light function, also, can protect the light-emitting element 320 away from being damaged by static electricity S.

Types of the mentioned keyboard 800 are not limited in an independent keyboard 800 (e.g. wired or wireless keyboard device) or an embedded keyboard assembling into a portable electric device (e.g. notebook or mobile phone).

Types of the mentioned keyboard are not limited .in a normal keyboard, a chocolate type keyboard, an island-style keyboard and a floating-style keyboard.

Refer to FIG. 5 again, the mentioned key module 100 in the embodiments of the present invention can be implemented on an electric device 900, thus, any one key in the electric device 900 can have an indicating light function, also, can protect the light-emitting element 320 away from being damaged by static electricity S.

Types of the mentioned electric device are not limited in the present invention, and are all in the scope of the present invention which is intended to be defined by the appended claims as long as the electric devices 900 with the mentioned key module 100. The mentioned electric device can be one of notebooks, mobile phones, video cameras, photo cameras, game devices, language translation devices, music players, display screens, digital photo frames and lamp tools.

Although the present invention has been described with reference to the preferred embodiments thereof, it is apparent to those skilled in the art that a variety of modifications and changes may be made without departing from the scope of the present invention which is intended to be defined by the appended claims.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise.

Thus, unless expressly stated otherwise, each feature disclosed is one example only of a generic series of equivalent or similar features.

What is claimed is:

1. A key module, comprising:
a metal substrate;
a circuit board stacked on the metal substrate, and installed with a plurality of apertures exposing the metal substrate beneath;
at least one light-emitting element disposed on the circuit board; and
at least one film flat disposed on the circuit board and covering the light-emitting element, the film comprising:
a first light-pervious portion disposed on the film aligning to the light-emitting element; and
a plurality of penetrating holes installed on the film, surrounding the light-pervious portion, and aligning with the apertures one on one.

2. The key module according to claim 1, wherein the film further comprises an opaque portion surrounding the light-pervious portion.

3. The key module according to claim 2, wherein the film is flexible, and is physically contacted with the light-emitting element.

4. The key module according to claim 3, wherein the first light-pervious portion is an opening.

5. The key module according to claim 3, wherein the first light-pervious portion is a light-pervious pattern.

6. The key module according to claim 2, wherein the film comprises a punched protrusion remaining a distance with the light-emitting element, wherein the first light-pervious portion is disposed on the punched protrusion.

7. The key module according to claim 6, wherein the first light-pervious portion is an opening.

8. The key module according to claim 6, wherein the first light-pervious portion is a light-pervious pattern.

9. The key module according to claim 1, wherein when the at least one light-emitting element is plural in quantity and the at least one film is single in quantity, the single film covers both the circuit board and the light-emitting elements.

10. The key module according to claim 1, wherein when the at least one light-emitting element and the at least one film are plural in quantity, each film covers the circuit board and one of the light-emitting elements.

11. The key module according to claim 1, wherein the circuit board is a membrane circuit board.

12. The key module according to claim 1, wherein each of the light-emitting elements is a light emitting diode.

13. The key module according to claim 1, wherein the film is made of polyester resin.

14. The key module according to claim 1 further comprising:
a key cap disposed above the film, and comprising a second light-pervious portion aligning to the first light-pervious portion.

15. The key module according to claim 14 further comprising:
a scissors-structure coupling both the key cap and the metal substrate, for moving the key cap vertically opposite to the metal substrate; and
an elastic member arranged between the metal substrate and the key cap for supporting and providing a restoring force when the key cap is pressed.

16. The key module according to claim 14 further comprising:
a key switch aligning to the elastic member, wherein when the scissors-structure is moved with the key cap to approach the metal substrate and to deform the elastic member, the elastic member activates the key switch.

17. A keyboard, comprising:
a key module according to claim 1.

18. An electric device, comprising:
a key module according to claim 1.
